(19) United States
(12) Patent Application Publication
(10) Pub. No.: US 2025/0288931 A1
(43) Pub. Date: Sep. 18, 2025

(54) AIR FILTER AND USE OF A FILTER ELEMENT IN AN AIR FILTER

(71) Applicant: MANN+HUMMEL GmbH, Ludwigsburg (DE)

(72) Inventors: Timo DIRNBERGER, Marbach (DE); Matthias HEINZMANN, Weinheim (DE)

(21) Appl. No.: 19/225,096

(22) Filed: Jun. 2, 2025

Related U.S. Application Data
(63) Continuation of application No. PCT/EP2023/084130, filed on Dec. 4, 2023.

(30) Foreign Application Priority Data
Dec. 6, 2022 (DE) 102022132353.6

(51) Int. Cl. B01D 46/00; B01D 46/12; B01D 46/62; B60H 3/06

(52) U.S. Cl. CPC B01D 46/0087; B01D 46/0036; B01D 46/12; B01D 46/62; B60H 3/0608; B01D 2271/022; B01D 2273/10; B01D 2275/207; B01D 2279/40

(57) ABSTRACT

An air filter has a filter housing. A first flat filter element and a second flat filter element, each having a filter medium body with an inflow surface and an outflow surface, are arranged in the filter housing. A flow guiding device selectively guides an air flow to be filtered through the first flat filter element and the second flat filter element in series or at least partially past the second flat filter element. The outflow surface of the first flat filter element and the inflow surface of the second flat filter element are spaced apart from each other and form a widening bypass channel. The filter medium body of at least one of the first flat filter element and the second flat filter element has an intrinsically changing height and has a reduced height in a region of a larger width of the bypass channel.

### CROSS-REFERENCE TO RELATED APPLICATIONS

This application is a continuation application of international application No. PCT/EP2023/084130 having an international filing date of Dec. 4, 2023, and designating the United States, the international application claiming a priority date of Dec. 6, 2022, based on prior filed German patent application No. 10 2022 132 353.6, the entire contents of the aforesaid international application and of the aforesaid German patent application being incorporated herein by reference.

### BACKGROUND

The invention concerns an air filter comprising:
two filter elements which are each embodied as a flat filter element and comprise a filter medium body with an inflow surface and an outflow surface,
a filter housing in which the two filter elements are arranged, and
and a flow guiding device for selectively guiding an air flow to be filtered through the two filter elements in series or at least partially past a second one of the two filter elements;
wherein the outflow surface of a first one of the filter elements and the inflow surface of the second one of the filter elements are spaced apart from each other so as to form a widening bypass channel.

Such an air filter is disclosed in US 2020/0376934 A1.

For high-separation cabin air filters, two filter elements are often used. A first one of the filter elements may be a prefilter element for separating larger particles and/or harmful gases. A second one of the filter elements may be a fine filter element, for example, a HEPA filter element, for separating finer particles. The filter elements in principle may be flowed through one after the other.

However, at low particle concentrations in the air to be filtered, a use of the fine filter element is not mandatorily required. In order to reduce the pressure loss upon flow through the air filter, the energy consumption of a blower of the air filter, and the noise development, the fine filter element may thus be bypassed in case of some air filters. For this purpose, the air is removed between the two filter elements after having flowed through the prefilter element. For this purpose, a bypass channel that is dimensioned sufficiently large is required between the filter elements. In order to create it, the filter elements must be correspondingly spaced apart from each other. This enlarges the installation space requirement of the air filter.

In the air filter known from the aforementioned US 2020/0376934 A1, two cuboid filter elements are provided which are positioned at a slant relative to each other so that between them a widening bypass channel is formed. By means of a bypass flap, the bypass channel may be selectively opened or closed in order to enable a bypass flow around the second filter element or to force a flow through the second filter element.

DE 10 2008 058 356 A1 discloses a filter element comprising a folded bellows with neighboring upper fold ridges and neighboring lower fold ridges, wherein the lower fold ridges are positioned in a base plane and wherein the upper fold ridges project away from the base plane with fold heights. The filter element is characterized by at least two different fold heights of the upper fold ridges. In this way, the filter element, while ensuring a high filter efficiency and optimized guiding of the fluid to be filtered, may be inserted in filter housings that deviate from a cuboid shape.

DE 10 2019 206 911 A1 describes an air filter element for an air filter device of a motor vehicle or of an interior air filter. The air filter element comprises a plate-shaped filter body of a filter material and a frame surrounding it. The filter material is folded such that the filter body comprises a plurality of neighboring folds which are connected by fold edges to each other and which follow each other in a filter length direction and extend in a filter transverse direction. The frame comprises two length end walls extending parallel to the filter transverse direction and two lateral strips extending parallel to the filter length direction. Within the filter body, at least one short fold group is formed of at least two folds which are following each other in the filter length direction and which are shorter than the neighboring folds in a filter height direction. At the respective short fold group, at least one cutout is formed in the frame. In the region of the respective cutout, a bending tab is formed at the frame which is bent away from the frame toward the folds of the respective short fold group. The bending tab is resting on at least some folds of the short fold group and is secured thereat by material fusion.

It is an object of the invention to enable in connection with an air filter with a prefilter element and with a fine filter element, which is to be selectively flowed through or bypassed, a compact construction and a minimal flow resistance, for example in case of bypassing the fine filter element.

### SUMMARY

This object is solved by an air filter comprising:
two filter elements each formed as a flat filter element and comprising a filter medium body with an inflow surface and an outflow surface,
a filter housing in which the two filter elements are arranged,
and a flow guiding device in order to selectively guide an air flow to be filtered through the two filter elements in series or at least partially past a second one of the filter elements;
   wherein the outflow surface of a first one of the filter elements and the inflow surface of the second one of the filter elements are spaced apart from each other so as to form a widening bypass channel, and
   wherein the filter medium body of at least one of the filter elements comprises an intrinsically changing height, wherein the filter medium body of the at least one filter element has a reduced height in a region of a larger width of the bypass channel.

The object is further solved by a use of a filter element, embodied as a flat filter element and comprising a filter medium body with an inflow surface and an outflow surface, wherein the filter medium body comprises an intrinsically changing height, in an air filter according to the invention.

Exemplary embodiments or variants of the invention are disclosed in the following description and accompanying drawing figures.

According to the invention, an air filter is provided. The air filter may be used for example as a cabin air filter of a motor vehicle.

The air filter comprises two filter elements. The filter elements are each embodied as a flat filter element and comprise a filter medium body with an inflow surface and an outflow surface. In operation, the air to be filtered flows through the respective filter medium from its inflow surface to its outflow surface.

The air filter comprises furthermore a filter housing in which the two filter elements are arranged.

Furthermore, the air filter comprises a flow guiding device in order to selectively guide an air flow to be filtered through the two filter elements in series or at least partially past a second one of the filter elements. The flow guiding device enables thus in a first operating state a forced serial flow through the first and the second filter elements one after another. The air flow is guided in this context first through the first filter element and subsequently through the second filter element. For describing the present invention, the filter element flowed through first is also referred to as the first filter element; the subsequently flowed-through filter element is also referred to as the second filter element. In a second operating state, the flow guiding device permits bypassing the (in the flow direction) second filter element. The air flow may be guided completely or partially, for example by at least 50%, past the second filter element.

The first filter element may be an adsorption filter element, for example containing active carbon.

The second filter element may be a HEPA filter element, for example of the filter class H13 according to EN 1822-1:2009 or better.

The outflow surface of a first one of the filter elements and the inflow surface of the second one of the filter elements are spaced apart from each other so as to form a widening bypass channel. The bypass channel widens in principle transversely to a flat extension direction of at least one of the filter elements. The bypass channel enables in the second operating state a diversion of the air filtered by the first filter element before it flows through the second filter element. In that the bypass channel widens in the direction of a bypass flow through the bypass channel or, in other words, toward an outlet of the air filter, the discharge of the air which has been filtered by the first filter element is facilitated; the flow resistance of the air filter is reduced.

According to the invention, the filter medium body of one of the filter elements comprises an intrinsically changing height, wherein the filter medium body in a region of a larger width of the bypass channel comprises a reduced height. In other words, the inflow surface and the outflow surface of the filter medium body along the bypass channel are spaced apart differently from each other. The filter elements may thus be arranged closely adjacent to each other without constricting the bypass channel. In this way, the installation space requirement for accommodating the two filter elements is kept small. The height or thickness of the filter medium body may be measured along the main passage direction for air through the filter medium body. Typically, the height or thickness is measured perpendicularly to the inflow surface or outflow surface of the filter medium body. The width of the bypass channel describes for example its expansion transversely to the main flow direction of the bypass flow through the bypass channel in the second operating state.

The filter medium body may be embodied with a filter mat, foam, a honeycomb body or porous material.

The filter medium body is formed with folds of different height. Both filter medium bodies are formed with folds. The filter medium body or the filter medium bodies may be comprised of folded filter paper. In the region of the larger width of the bypass channel, lower folds are provided. In other words, folded edges of the folds of the one filter element which are facing the other filter element are spaced apart differently than the folded edges facing away from the other filter element. As the folds become lower (smaller distance of the folded edges), the bypass channel thus increasingly widens.

The inflow surface of the first filter element and the outflow surface of the second filter element extend parallel to each other. In this way, a particularly compact configuration of the air filter may be obtained.

The height of the filter medium body may decrease continuously in the widening direction or flow direction of the bypass channel. This is advantageous with respect to the flow through the bypass channel.

As an alternative, the height of the filter medium body may decrease in a stepwise manner in the widening direction or flow direction of the bypass channel. This may simplify the manufacture of the filter element.

It is also preferred that both filter elements comprise a filter medium body which has an intrinsically changing height. In this context, the two filter medium bodies each have a reduced height in the region of the larger width of the bypass channel. In this context, the two filter elements may be arranged particularly close to each other while the bypass channel may still be flowed through with minimal resistance.

A smallest height of one or both of the filter medium bodies, for example of the folds of the one filter element or both of the filter elements may amount to at least about 5 mm, for example at least about 8 mm, and/or at most about 20 mm, for example at most about 15 mm.

A largest height of the one or both of the filter medium bodies, for example of the folds of the one filter element or both of the filter elements, may amount to at least about 30 mm, for example at least about 40 mm, and/or at most about 70 mm, for example at most about 60 mm.

The filter element with changing height may comprise at least one frame element. The frame element enables a lateral sealing action of the filter medium body. The frame element may be a lateral band for sealing folds. Alternatively or in addition, the frame element may comprise a plastic frame in which the filter medium body is indirectly or directly glued or injection-molded.

The frame element protrudes past the filter medium body in the region of the lower height. For example, the frame element or lateral band may protrude past folded edges of the folds in the region of the lower folds. The frame element may have a substantially constant height. The frame element comprises at least one section of reduced protrusion, for example a recess. In other words, the protrusion of the frame element is locally reduced. The filter housing comprises a projection adjacent to the section of the lower protrusion. The projection engages at least in sections in the recess. The projection may project from a lateral wall of the filter housing inwardly. Due to the projection, the filter element may be installed only in such an orientation in which the position of the section of reduced protrusion coincides with the position of the projection. In this way, it is ensured that the bypass channel widens in the desired direction. An erroneous installation of the filter element is excluded. In addition, the installation of unsuitable filter elements may be prevented by the projection which, for example, concerns filter elements that do not fulfill certain technical requirements, for example, a predetermined separation efficiency.

When both filter elements have a changing height, both filter elements each may comprise at least one frame element, respectively, which protrudes in the region of the lower height past the filter medium body, respectively, wherein the frame elements comprise each at least one section of reduced protrusion, for example a recess. Adjacent to the sections of reduced protrusion, the filter housing may comprise a projection, respectively. At the filter housing a common projection is provided which adjoins both sections of reduced protrusion, for example engages both recesses at least in sections. The manufacture of the filter housing may be simplified, as needed, when only one common projection is provided.

One of the filter elements, for example the filter element with changing height and/or a filter element with relatively better separation may comprise a seal. The seal may seal two housing parts of the filter housing relative to each other.

The seal forms a first and a second seal section, wherein the first seal section surrounds the filter medium body and the second seal section encloses a flow-through opening. The first seal section serves for sealing the filter medium body in relation to the filter housing, for example the first seal section seals an inflow-associated raw side relative to an outflow-associated clean side. In addition, the first seal section may serve for sealing housing parts of the filter housing. The second seal section with the opening serves typically for sealing housing parts of the filter housing. The opening is in principle free of filter material. The second seal section with the opening may be referred to also as a handle at the filter element. The second seal section with the opening is located in principle (radially) outside of a cross section of the filter medium body. The first and the second seal sections may comprise a common segment of the seal.

The flow path of an air flow guided serially through the two filter elements may extend through the opening in the second seal section. This may simplify the flow guidance and the configuration of the filter housing.

A fluid connection between the outflow side of the second filter element and an outlet of the filter housing is established only via the flow-through opening. In case of serial flow through both filter elements, the entire filtered air flow then flows through the opening.

The seal may be formed with polyurethane, for example polyurethane foam. The seal may be formed integrally at the filter medium body. Hardness of the seal may amount to at least about 13 Shore A and/or at most about 25 Shore A. In another embodiment, the seal may be injection-molded to the plastic frame of a filter element, wherein the seal for example may be comprised of a thermoplastic elastomer material. The seal may comprise for example one or a plurality of sealing lips which is advantageous in order to achieve a particularly good seal tightness with comparatively minimal seal pretension forces.

The second seal section of the seal may be stiffened by a stiffening part. In this way, it may be ensured that the second seal section will contact the provided seal locations at the filter housing. The seal may be formed integrally at the reinforcement part. For example, the reinforcement part may be embedded in the seal. In another embodiment, the plastic frame may surround the flow-through opening which is enclosed by the second seal section, wherein for example the second seal section is also injection-molded onto the plastic frame.

An air guiding rib may be provided at the second seal section. The flow through the air filter may be optimized in this way for example in the region of the flow-through opening.

The air guiding rib is embodied as one piece together with the reinforcement part. This simplifies the manufacture of the filter element. The flow guiding device is embodied with a flap which closes the bypass channel in a first position and opens the bypass channel in a second position. By pivoting the flap, it is possible to switch between the operating states in a particularly easy manner. In the second position, the flap may prevent entirely or partially a flow through the flow-through opening of the second seal section of the seal. The flap may comprise one or a plurality of sealing lips, for example for contacting seal locations of the filter housing. Typically, a sealing lip between the filter housing and the flap is provided at the bypass channel at the outlet side, wherein the sealing lip may be provided at the filter housing or at the flap.

The present invention also includes a use of a filter element, which is formed as a flat filter element and comprises a filter medium body with an inflow surface and an outflow surface, wherein the filter medium body comprises an intrinsically changing height, in an air filter according to the invention, as previously described. The filter element is used thus in an air filter with a further filter element which is embodied as a flat filter element and comprises a further filter medium body with a further inflow surface and a further outflow surface, wherein the air filter comprises a filter housing in which the two filter elements are arranged when in use, and wherein the air filter furthermore comprises a flow guiding device in order to selectively guide an air flow to be filtered through the two filter elements in series or at least partially past one of the filter elements, and wherein a widening bypass channel is formed between the filter elements, wherein the filter element comprises a reduced height in the region of the larger width of the bypass channel. The filter element with changing height may be (in the flow direction) the first or the second filter element. In use according to the invention, the tapering geometry of the filter element is utilized in order to create, with a minimal installation space requirement, a fluidically advantageous bypass channel between the filter element and the further filter element.

The filter medium body may be embodied with a filter mat, foam, a honeycomb body or porous material.

The filter medium body is formed with folds of different height. The filter medium body may be comprised of a folded filter paper. In use, the filter element is arranged in use such that lower folds are located in the region of the larger width of the bypass channel.

The height of the filter medium body may decrease continuously. This is advantageous in respect to the flow through the bypass channel.

As an alternative, the height of the filter medium body may decrease in a stepwise manner. This may simplify the manufacture of the filter element.

The filter element may comprise at least one frame element. The lateral band enables a lateral sealing action of the filter medium body. The frame element may be a lateral band for sealing folds. The frame element protrudes in the region of the lower height past the filter medium body. For example, the frame element or the lateral band may protrude past folded edges of the folds in the region of the lower folds. The frame element may comprise a substantially constant height. The frame element comprises at least one section of minimal protrusion, for example a recess. In other words, the protrusion of the frame element is locally reduced. When the filter housing comprises a projection, a frame element designed in this way may force a defined installation position of the filter element. An installation of the filter element in the filter housing is only possible in that the projection is arranged adjacent to the section of reduced protrusion, for example engages the recess at least in sections.

The filter element may comprise a seal which forms a first and a second seal section, wherein the first seal section surrounds the filter medium body and the second seal section forms a flow-through opening. The first seal section serves for sealing the filter medium in relation to the filter housing, for example, the first seal section may seal an inflow-associated raw side in relation to an outflow-associated clean side. In addition, the first seal section may serve for sealing housing parts of the filter housing. The second seal section with the opening serves typically for sealing housing parts of the filter housing. The opening is in principle free of filter material. The second seal section with the opening is located in principle (radially) outside of a cross section of the filter medium body. The first and the second seal sections may comprise a common segment of the seal.

The filter element comprising the seal is used typically as a second filter element in flow direction.

The flow path of an air flow guided serially through the two filter elements may extend through the opening in the second seal section.

A fluidic connection between the outflow side of the (second) filter element and an outlet of the filter housing may be established only through the flow-through opening. In case of a serial flow through both filter elements, the entire filtered air flow then flows through the opening.

The seal may be formed with polyurethane, for example polyurethane foam. The seal may be formed integrally at the filter medium body. A hardness of the seal may amount to at least 13 Shore A and/or at most 25 Shore A.

The second seal section of the seal is stiffened by a reinforcement part. In this way, it may be ensured that the second seal section contacts the predetermined seal locations of the filter housing. The seal may be formed integrally at the reinforcement part. For example, the reinforcement part may be embedded in the seal.

At the second seal section, an air guiding rib may be provided. The flow through the air filter may be optimized in this way for example in the region of the opening.

The air guiding rib is formed as one piece together with the reinforcement part. This simplifies the manufacture of the filter element.

### BRIEF DESCRIPTION OF DRAWINGS

Further features and advantages of the invention result from the following detailed description of exemplary embodiments of the invention with the aid of the accompanying drawing figures illustrating details according to the invention. The aforementioned and still to be explained features may be realized each individually or several combined in any random expedient combinations in variants of the invention. The features illustrated in the drawing figures are illustrated such that the particularities according to the invention may be made clearly visible.

FIG. 1 shows an air filter according to the invention with two conical flat filter elements between which a widening bypass channel is formed in a schematic section view.

FIG. 2 shows, in flow direction, the second filter element of the air filter of FIG. 1 in a schematic section illustration.

FIG. 3 shows a cuboid filter element for use as a second filter element with a first conical filter element in an air filter similar to FIG. 1 in a schematic perspective view.

### DETAILED DESCRIPTION

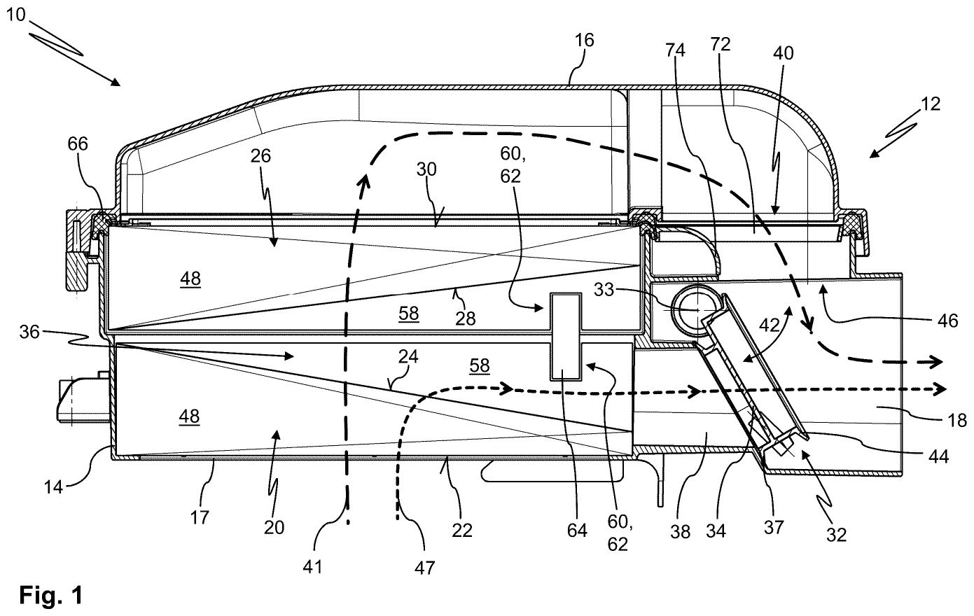

FIG. 1 shows an air filter 10. The air filter 10 comprises a filter housing 12 with a housing bottom part 14 and a housing top part 16. Air to be filtered is guided through an inlet 17 into the filter housing 12. Filtered air is introduced through an outlet 18 of the filter housing 12, for example, into a passenger cabin of a motor vehicle, not illustrated in detail.

Two filter elements 20, 26 are arranged in the filter housing 12. The two filter elements 20, 26 are formed as flat filter elements. The first filter element 20 in flow direction comprises a first inflow surface 22 and a first outflow surface 24. The second filter element 26 is provided in flow direction behind the first filter element 20. The second filter element 26 comprises a second inflow surface 28 and a second outflow surface 30. As shown, the first inflow surface 22 of the first filter element 20 and the second outflow surface 30 of the second filter element 26 extend parallel to each other.

The first filter element 20 may be a so-called ambient or prefilter element and for example contain active carbon for adsorption of harmful gases. The second filter element 26 may be a HEPA filter element for filtering fine particles.

The air filter 10 comprises furthermore a flow guiding device 32 which here is formed by a flap 34 pivotable by means of a pivot drive, not illustrated in detail, about an axis 33. In FIG. 1, the air filter 10 is in the first operating state in which the two filter elements 20, 26 are flowed through one after another (serially). For this purpose, the flap 34 closes in a first position a bypass channel 36 which is formed between the two filter elements 20, 26. A seal lip 37 which is formed at the flap 34 may contact for this purpose seal-tightly a mouth 38 of the bypass channel 36 formed by the filter housing 10. In the first operating state, the filtered air flows, after passing the second filter element 26, through a flow-through opening 40, which here is formed in a transition region between the housing top part 16 and the housing bottom part 14, to the outlet 18. A flow path 41 of the air in the first operating state is schematically indicated in FIG. 1 with dashed arrows.

In a second operating state, the flow guiding device 32 opens the bypass channel 36. The flap 34 for this purpose is pivoted away from the mouth 38, compare the pivot direction 42 indicated by an arrow. In a second position, not illustrated in more detail, the flap 34 may close with a further seal lip 44 a clean air passage 46 which is arranged in flow direction between the second filter element 26 and the outlet 18.

In the second operating state, the air which has been filtered by the first filter element 20 flows through the bypass channel 36 to the outlet 18. In FIG. 1, a flow path 47 of the air in the second operating state is schematically indicated with dotted arrows. The bypass channel 36 widens toward its mouth 38. This reduces the flow resistance in the air filter 10 in addition to the elimination of the flow resistance of the second filter element 26.

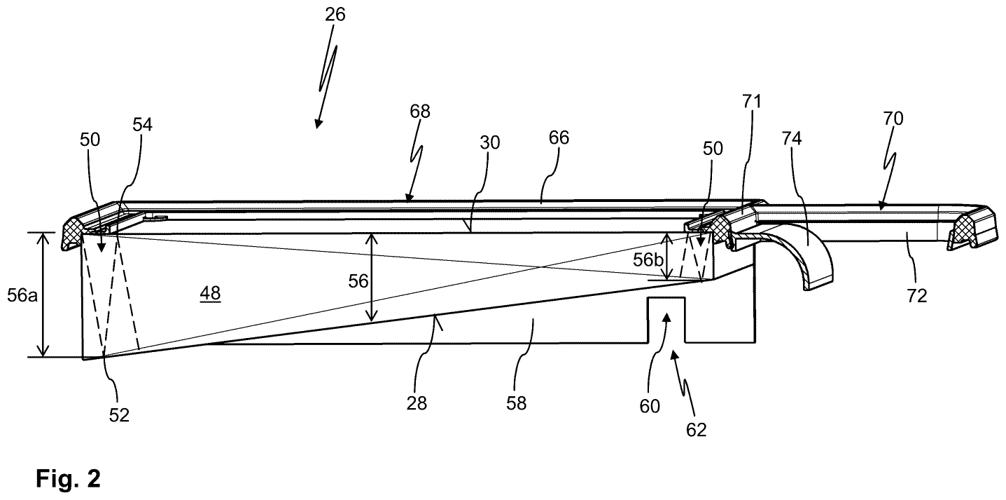

The two filter elements 20, 26 comprises each a filter medium body 48. In the illustrated embodiment, the filter medium body 48 is formed respectively of a folded filter paper. This is illustrated in FIG. 2 in an exemplary fashion for the second filter element 26. Folds 50 of the filter medium body 48 are delimited at the inflow side and at the outflow side by folded edges 52 or 54, respectively. A height 56 (measurable perpendicularly to the outflow side or inflow side) or thickness of the filter medium body 48, which corresponds in the illustrated embodiment to the height of the folds 50, decreases in this context along the bypass channel 36. A largest height 56a of the filter medium body 48 or of its folds 50 may amount to about 48 mm, for example. A smallest height 56b of the filter medium body 48 or of its folds 50 may amount to about 11 mm, for example.

Here, the thickness of the filter elements 20, 26 is reduced continuously in flow direction of the bypass channel 36 in the second operating state (in FIG. 1 from left to right). Correspondingly, the bypass channel 36 widens toward the mouth 38 continuously. The air which is flowing across the entire surface of the first filter element 20 into the bypass channel 36 has thus available a cross section that increases toward the mouth 38 so that the differential pressure between the first inflow surface 22 and the outlet 18 required for flow through the bypass channel 36 remains minimal. This lowers the energy consumption and may increase the mileage of a motor vehicle with the air filter 10.

The two filter elements 20, 26 comprise here respective frame elements 58 in the form of lateral bands which seal the folds 50 transversely to the fold edges 52, 54 and transversely to the respective inflow or outflow surfaces 22 to 30, compare FIGS. 1 and 2. In embodiments, the frame element 58 may be part of a plastic frame in which the filter medium body 48 is fastened directly or indirectly. For example, the filter medium body 48 may be glued directly into the plastic frame or the material of the plastic frame may be molded around it. Alternatively, the filter medium body may comprise lateral bands by means of which the filter medium body 48 is connected indirectly to the plastic frame, for example glued. With folds 50 becoming lower, the frame element 58 protrudes increasingly past the inflow side folded edges 52 of the second filter element 26 or the outflow side folded edges of the first filter element 20. Aside from a respective recess 60, the frame elements 58 are of the same height throughout. The recesses 60 each form a section 62 of reduced protrusion in the frame element 58.

At a sidewall of the filter housing 12, a projection 64 is formed, compare FIG. 1. In the mounted state of the filter elements 20, 26, the projection 64 engages the recess 60 of the respective frame element 58. A filter element 20, 26 may thus be inserted into the filter housing 12 only when it is oriented correctly and when its frame element 58 has a reduced protrusion at the correct location.

The second filter element 26 comprises presently a seal 66, here of polyurethane foam. The seal 66 forms two, here rectangular, seal sections 68, 70 which comprise a common seal segment 71. A first seal section 68 is arranged externally and extends circumferentially at the outflow surface 30 of the filter medium body 48 of the second filter element 26. A second seal section 70 protrudes-like a handle-away from the filter medium body 48 and is free of filter material. The second seal section 70 surrounds the flow-through opening 40 which is fluidically positioned in front of the clean air passage 46 in the illustrated embodiment.

On the one hand, the seal 66 serves for sealing housing bottom part 14 and housing top part 16 relative to each other. On the other hand, the first seal section 68 serves for sealing the second filter element 26 in relation to the filter housing 12 so that the entire air must pass through the filter medium body 48 of the second filter element 26 in the first operating state.

The second seal section 70 is reinforced by a reinforcement part 72. An air guiding rib 74 is formed as one piece together with the reinforcement part 72. In the first operating state, the air guiding rib 74 serves for guiding the filtered air in the region of the flow-through opening 40 to the clean air passage 46. In embodiments, the reinforcement part 72 may be formed as one piece together with the plastic frame which comprises the frame elements 58.

The sealing action of the first filter element 20 in relation to the filter housing 12 may be realized via its frame elements 58, here the lateral bands and head bands, not illustrated in detail, of the first filter element. The second filter element 20 also comprises typically two head bands, not illustrated in detail, in addition to two lateral bands. The lateral bands and the head bands form a circumferentially extending frame of the respective filter medium bodies 48.

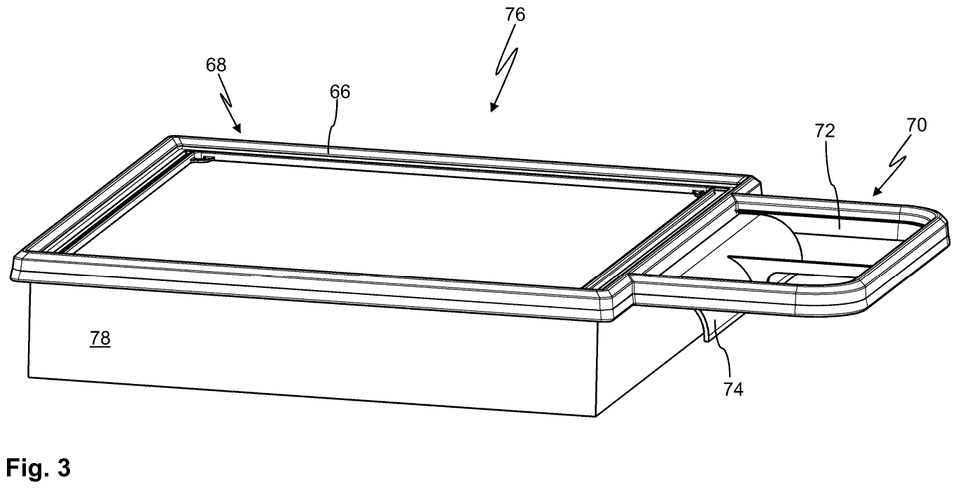

FIG. 3 shows a further second filter element 76 which could be used in place of the second filter element 26 in an air filter similar to that illustrated in FIG. 1. The filter element 76 comprises a cuboid filter medium body 78. A cuboid filter element 76 is to be used in accordance with the invention together with a tapering filter element. In this context, as here illustrated, either the second filter element 76 may be embodied cuboid and the first filter element 20 with changing height 56, for example folds 50 of different height; as an alternative, the first filter element could be embodied cuboid and the second filter element with changing height, for example folds of different height (not illustrated here). In both cases, the decreasing height (thickness) or the folds becoming lower of the one filter element cause widening of the bypass channel 36 formed between the two filter elements. When using a cuboid filter element, it is understood that a projection 64 at the filter housing 12 interacts only with a protruding lateral band, recessed in sections, of the tapering filter element for securing the correct installation position. In regard to the configuration of the seal 66 as well as of the reinforcement part 72 and of the air guiding rib 74, the second filter element 76 of FIG. 3 corresponds to the above-described second filter element 26, compare FIGS. 1 and 2.

In summarizing, the invention concerns an air filter with two filter elements which are flowed through in a first operating state one after another (serially). Between the filter elements, a bypass channel for at least partial bypassing of one of the filter elements in a second operating state is provided. The bypass channel widens in the direction of the bypass flow through the bypass channel which is produced in the second operating state. At least one of the filter elements comprises a filter medium body whose thickness—in direction of the bypass flow-decreases along the bypass channel. The filter medium body of changing height or thickness may be obtained by folding of a filter paper. The corresponding installation position of the tapering filter element may be ensured in that a frame element, for example a lateral band, for sealing the filter medium body has a substantially constant height so that it protrudes in sections past the filter medium body, for example past the lower folds, wherein the lateral band however is recessed in sections. A projection of the filter housing may engage in this section of reduced protrusion.

### LIST OF REFERENCE CHARACTERS

air filter 10
filter housing 12
housing bottom part 14
housing top part 16
inlet 17
outlet 18
first filter element 20
first inflow surface 22
first outflow surface 24
second filter element 26
second inflow surface 28
second outflow surface 30
flow guiding device 32
axis 33
flap 34
bypass channel 36
seal lip 37
mouth 38
flow-through opening 40
flow path 41 in case of serial flow
pivot direction 42
further seal lip 44
clean air passage 46
flow path 47 in case of bypass flow
filter medium 48
folds 50
fold edges 52, 54
height 56 of the folds 50
largest height 56a
smallest height 56b
lateral band 58
recess 60
section 62 of reduced protrusion
projection 64
seal 66
first seal section 68
second seal section 70
common seal segment 71
reinforcement part 72
air guiding rib 74
second filter element 76
filter medium 78

What is claimed is:

1. An air filter comprising:
a filter housing;
a first flat filter element and a second flat filter element, each comprising a filter medium body with an inflow surface and an outflow surface, wherein the first flat filter element and the second flat filter element are arranged in the filter housing; and
a flow guiding device configured to selectively guide an air flow to be filtered through the first flat filter element and the second flat filter element in series or at least partially past the second flat filter element;
wherein the outflow surface of the first flat filter element and the inflow surface of the second flat filter element are spaced apart from each other and together form a widening bypass channel; and
wherein the filter medium body of at least one of the first flat filter element and the second flat filter element comprises an intrinsically changing height and has a reduced height in a region of a larger width of the bypass channel.

2. The air filter according to claim 1, wherein the filter medium body of the at least one of the first flat filter element and the second flat filter element comprises folds of different fold height, wherein the folds of different fold height include lower folds in the region of the larger width of the bypass channel.

3. The air filter according to claim 1, wherein the inflow surface of the first flat filter element and the outflow surface of the second flat filter element extend parallel to each other.

4. The air filter according to claim 1, wherein the intrinsically changing height of the filter medium body of the at least one of the first flat filter element and the second flat filter element decreases continuously or stepwise.

5. The air filter according to claim 1, wherein both the filter medium body of the first flat filter element and the filter medium body of the second flat filter element comprise the intrinsically changing height and each have the reduced height in the region of the larger width of the bypass channel.

6. The air filter according to claim 1, wherein the at least one of the first flat filter element and the second flat filter element provided with the filter medium body comprising the intrinsically changing height comprises at least one frame element protruding past the filter medium body in the region of the reduced height of the filter medium body, wherein the at least one frame element comprises at least one section of reduced protrusion, and wherein the filter housing adjacent to the at least one section of reduced protrusion comprises a projection engaging the at least one section of reduced protrusion.

7. The air filter according to claim 6, wherein the at least one section of reduced protrusion is a recess and the projection engages the recess.

8. The air filter according to claim 1, wherein at least one of the first flat filter element and of the second flat filter element comprises a seal comprising a first seal section and a second seal section, wherein the first seal section surrounds the filter medium body of the at least one of the first flat filter element and of the second flat filter element, and wherein the second seal section encloses a flow-through opening.

9. The air filter according to claim 8, wherein a flow path of an air flow guided serially through the first flat filter element and the second flat filter element extends through the flow-through opening.

10. The air filter according to claim 9, wherein a fluidic connection between the outflow surface of the second flat filter element and an outlet of the filter housing is established only through the flow-through opening.

11. The air filter according to claim 8, wherein the filter housing comprises two housing parts and wherein the seal seals the two housing parts relative to each other.

12. The air filter according to claim 1, wherein the flow guiding device comprises a flap configured to close the widening bypass channel in a first position of the flap and configured to open the widening bypass channel in a second position of the flap.

13. A method of using a filter element in an air filter according to claim 1, the method comprising:
embodying the filter element as a flat filter element comprising a filter medium body with an inflow surface and an outflow surface, wherein the filter medium body comprises an intrinsically changing height.

14. The method of claim 13, further comprising forming the filter medium body with folds of different height.

15. The method of claim 13, further comprising decreasing the intrinsically changing height of the filter medium body continuously or stepwise.

16. The method of claim 13, further comprising providing the flat filter element with at least one frame element protruding in a region of a lower height of the filter medium body past the filter medium body and comprising at least one section of reduced protrusion formed as a recess.

17. The method of claim 13, further comprising providing the flat filter element with a seal comprising a first seal section and a second seal section, wherein the first seal section surrounds the filter medium body and the second seal section encloses a flow-through opening.

18. The method of claim 17, further comprising positioning the flat filter element in the air filter such that a flow path of an air flow guided through the air filter extends through the flow-through opening after exiting from the outflow surface of the flat filter element.

19. The method of claim 17, further comprising establishing a fluidic connection between the outflow side of the flat filter element and an outlet of the filter housing only through the flow-through opening.
